(19) United States
(12) Patent Application Publication
(10) Pub. No.: US 2004/0226778 A1
(43) Pub. Date: Nov. 18, 2004

(54) Guiding system for an elevator

(76) Inventors: Alexandr Vladimirovich Tarasov, St. Petersburg (RU); Oleg Ivanovich Efimov, St. Petersburg (RU)

Correspondence Address: HOUSTON ELISEEVA, 4 MILITIA DRIVE, SUITE 4, LEXINGTON, MA, 02421, US

(21) Appl. No.: 10/861,130

(22) Filed: Jun. 4, 2004

Related U.S. Application Data
(63) Continuation of application No. PCT/RU01/00579, filed on Dec. 26, 2001.

(30) Foreign Application Priority Data
Dec. 6, 2001 (RU) RU 2001132883

(51) Int. Cl. B66B 7/02

(52) U.S. Cl. 187/406

(57) ABSTRACT

The invention relates to hoists constructions with a drive mechanism installed on the hoist and concerns the guide construction. The guiding system of the hoist contains the guide having central part and side elements and having arch or triangular form in cross-section, supporting elements fixed in the central part of the guide along the length of the guide and serving as the support for the driving element of the hoist drive when it moves, supporting surfaces executed on each side element of the guide along its length and serving for location fixation of the driving element of the hoist drive and the movable part of the hoist itself relative to supporting elements, attachment points of the guide to the external support executed on each side element of the guide.

### RELATED APPLICATIONS

This application is a Continuation of PCT application serial number PCT/RU01/00579 filed on Dec. 26, 2001, which was published in the Russian language under PCT Article 21(2), and which claims priority to RU 2001132883 filed on Dec. 6, 2001 both of which are incorporated herein by reference in their entirety.

### FIELD OF THE INVENTION

The invention relates to hoists constructions with a drive mechanism installed on the hoist and concerns a guide construction.

### BACKGROUND OF THE INVENTION

A large number of hoists constructions is known where drives are installed on the hoist, for example, rack hoists. For such types of hoists the important problem is interaction of a driving element of the hoist drive mechanism with the guides system and, first of all, provision of construction rigidity in the planes transverse to the hoist movement, and exclusion of driving element vibrations relative to supporting elements with which it interacts in the process of hoist movement.

This problem is solved by installation of several independent guides forming a guiding system. The following constructions of guiding hoists can be given as typical examples.

In the construction according to EP patent No 1004537 “Hoist Mechanism Installed in a Tower”, Int.Cl B66B9/02, priority of 23.11.98, three vertical guides are placed in vertexes of a triangular along which the hoist moves.

The construction is known according to the U.S. Pat. No. 5,751,076 “Hoist system for an elevator”, Int.Cl B66B 11/04, priority of 19.01.96, where the hoist car moves along two guides arranged along the sides of the hoist car.

The hoist of the rack type is known according to the Japan patent 5-17153, Int.Cl B66B9/02, priority of 1993 which moves between at least two guides and that have supporting surfaces.

The construction is also known according to the U.S. Pat. No. 5,501,295, “Hoist System”, Int.Cl B66B 9/00, priority of 17.02.92 containing the guides, arranged at the hoist car corners, on which supporting surfaces are executed.

All considered constructions cannot provide acceptable characteristics for high-speed hoists of large extent and noticeable load capacity having the drive installed on the hoist. It is connected with the fact that, first, it is difficult to provide precise installation of each separate guide strictly parallel in the process of hoist mounting at large height in the well so that precise interaction of driving element with supporting elements takes place. Second, these separate guides are not sufficiently rigidly connected to each other and will be distorted in the process of operation which will lead to position change of the driving element relative to supporting elements on the guides. The hoists of such type did not receive acceptance in hoisting equipment of noticeable height and load capacity and operating at high speeds because of these reasons.

The hoist construction is known according to RU patent No 2107016, “Hoist”, Int.Cl B66B 9/02, priority of 14.08.96, of the same authors as the proposed invention is, (see as well International Application PCT/RU 98/00021) which has been chosen as a prototype. In this invention the problem of application of cog (pin tooth, spindle) gear as an elevating mechanism providing large load capacity and reliability but without noticeable levels of vibration and noise has been solved. The construction of hoist guides in the mentioned patent and international application is nor described and not disclosed.

### DISCLOSURE OF THE INVENTION

The proposed invention solves the problem of construction creation of the hoist guiding system using a drive installed on the hoist and providing greater load capacity and speed of hoist movement. In this case the guides system possesses moderate specific consumption of materials and can be executed in industrial conditions, and mounted with high accuracy of supporting surfaces on the site of hoist installation without noticeable labor expenditures.

The guiding system of the hoist contains a guide having a central part and side elements and executed arch or triangular in cross section. The system contains also supporting elements fixed in the central part of the guide along the length of the guide and serving as a support of a driving element of the hoist drive in its movement; supporting surfaces executed on each side element of the guide along its length and serving for location fixation of the driving element of the hoist drive and moving part of the hoist itself relative to supporting elements and attachments points of the guide to the external support executed on each side element of the guide.

The guiding system includes a main element—a guide which in the cross-section represents itself an arch or has a triangular profile. Such execution of the guide provides rigidity of the construction, because the supporting elements on which the hoist driving element bears in movement are arranged in the center of the arch, and attachment points of the guide to the external support are arranged on each side element which provides stability of the construction.

The supporting surfaces are executed on each side element of the guide. The rollers or sliders of the hoist drive move along the supporting surfaces which provide location fixation of the driving element relative to supporting elements fixed in the central part of the guide arch. Besides, they provide additional rigidity of the guide in interaction with rollers or sliders and the whole construction of the hoist drive, because they complete the guide arch and form an original tie which moves along the guide together with the hoist movement.

The supporting surfaces fix the position of the hoist drive and driving element relative to supporting elements providing its alignment.

Such construction of the guide provides necessary rigidity and strength of the system, alignment of the driving element relative to supporting elements, at that it possesses small specific consumption of materials, is compact and can be executed with pre-required accuracy in industrial conditions and is mounted rather easy on the site because it consists from one unit as an assembly.

In a particular case the supporting surfaces are executed symmetrically relative to the surface going through the rise of the arch profile along the length of the guide or the vertex of the triangular profile of the guide. In this case the profile creation of the guide construction is simplified. However, the arch or the triangular profile with regard to location of the hoist platform can be executed non-symmetrical as well, then the supporting surfaces are arranged non-symmetrically relative to the surface going through the rise of the arch profile.

The supporting surfaces can be executed on the flanges formed on the side elements of the guide. In this case they can be arranged on the flanges both on the side of the guide facing the driving element and on the opposite side of the guide. In this case the supporting surface from the external side of the side element of the guide is arranged at the angle of α between the plane going through this supporting surface and the plane going through the rise of the arch profile of the guide or the vertex of the triangular profile of the guide and ranges from 30° to 130°, and the supporting surface from the internal side of the side element of the guide is arranged at the angle of β between the plane going through this supporting surface and the plane going through the rise of the arch profile of the guide construction or the vertex of the guide triangular profile and ranges from 30° to 130°. Thus, the supporting surfaces from the external and internal sides of the guide can be oriented independently of one another, at different angles. The arch profile of the guide can be curved outside or inside relative to the plane going through the axes of supporting elements.

The supporting elements, in particular, can be executed in the form of cogs of the spindle gearing or rack teeth of the rack gear.

The central part of the guide can be executed Π-shaped in cross-section. The cogs of the spindle gear are fixed in the side flanges of the Π-shaped central part of the mentioned guide.

The most technological way to execute the guide is in the form of the rolled products.

If the hoist is of large load capacity and dimensions then the guides system can contain two and more additional guides fixed to the external support from two sides of the mentioned guide, each of the additional guides containing additional supporting surfaces. These additional guides suppress transverse movements and thus assist alignment of the driving element relative to supporting elements in case of large dimensions of the hoist car.

### BRIEF DESCRIPTION OF THE DRAWINGS

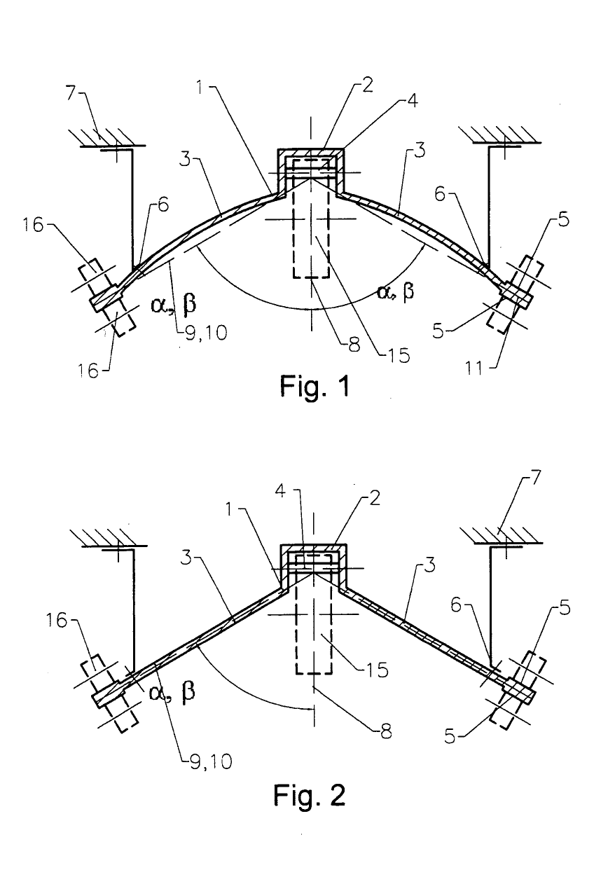

In FIG. 1 the guiding system section is given with the arch cross-section of the guide;

In FIG. 2—the section of the guiding system with triangular cross-section of the guide;

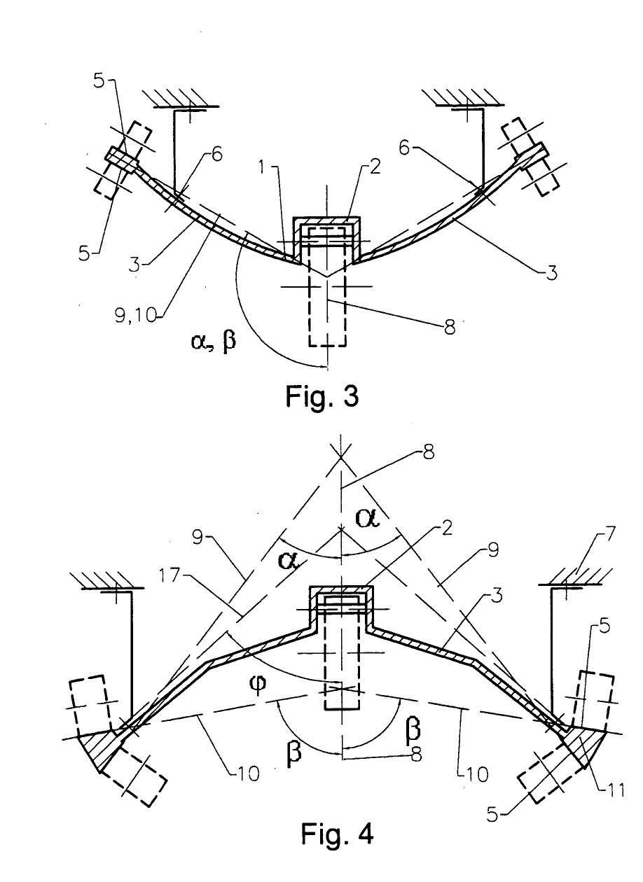

In FIG. 3—the section of the guiding system with the arch profile of the guide curved outside;

In FIG. 4—the section of the guiding system with supporting surfaces on the flanges arranges on the side of the guide facing the driving element and on the reverse side of the guide as well at different angles;

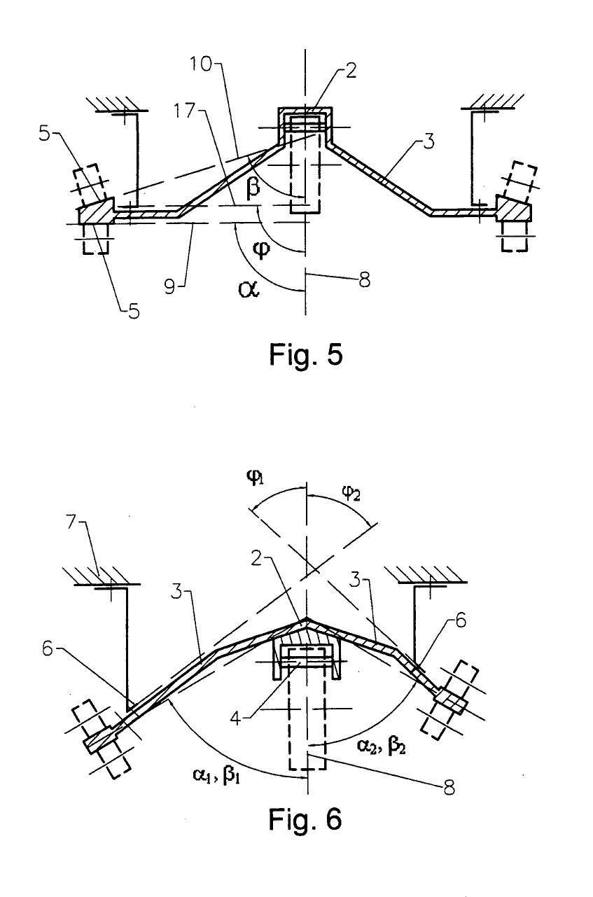

In FIG. 5—one more example of the arch form of the guide;

In FIG. 6—the example of non-symmetric guide;

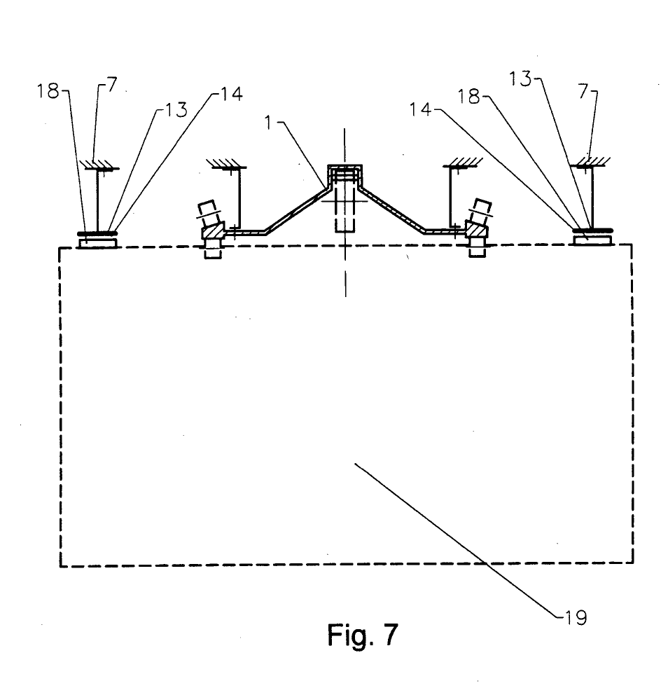

In FIG. 7—the guiding system with additional guides.

### DESCRIPTION OF THE PREFERRED EMBODIMENTS

The guiding system of the hoist (FIG. 1-FIG. 6) contains the guide 1, having central part 2 and side elements 3; supporting elements 4, fixed in the central part 2 of the guide 1 along its length; supporting surfaces 5 executed on each side element 3 of the guide 1 along its length; attachment points 6 of the guide 1 to the external supporting 7 executed on each side element 3 of the guide 1. The driving element 15 of the hoist contacts supporting elements 4. The rollers 16 (or sliders) of the hoist bear supporting surfaces 5. The guiding system of the hoist is arranged along the height of the hoist well, but it can be arranged at an angle and even has horizontal parts.

In FIG. 1-FIG. 5 and FIG. 7 the examples of the guide 1 execution are given when supporting surfaces 5 are executed symmetrically relative to the plane 8 going through the rise of the arch profile along the length of the guide 1 (FIG. 1, FIG. 3-FIG. 5, FIG. 7) or the vertex of the triangular profile of the guide 1 (FIG. 2).

The supporting surfaces 5 are executed along the whole length of the guide 1, supporting elements 4 are arranged along the whole length of the guide 1 as well.

The supporting elements 4 are shown in figures in the form of cogs of the spindle gear but they can be executed in the form of rack teeth of rack gear or elements of helical gear.

The supporting surfaces 5 of the guide 1 are executed on the flanges 11 of the side elements 3. The supporting surface 5 (FIG. 4) on the side of the guide 1 facing the driving element 15 is arranged at an angle of α between the plane 9 going through this supporting surface 5 and the plane 8 going through the rise of the arch profile of the guide or the vertex of the triangular profile of the guide and makes an angle 30°÷130°. The supporting surface 5 from the reverse side of the guide 1 is arranged at an angle βbetween the plane 10 going through this supporting surface and the plane 8 going through the rise of the arch profile of the guide 1 construction or the vertex of the triangular profile of the guide 1 makes also an angle 30°÷130° In FIG. 1-FIG. 3 and FIG. 6 the examples of the guiding system are given when supporting surfaces 5 on both the side of the guide 1 facing the driving element 15, and reverse side of the guide 1 are arranged in parallel for each side element 3, that is have the same values of angles α and β. The examples of the guiding system are given in FIG. 4 and FIG. 5 where supporting surfaces 5 are arranged both on the side of the guide facing the driving element 15 and on the reverse side of the guide have different values of angles α and β. Thus, how to arrange supporting surfaces 5 of the guide 1 is determined by specific construction of the hoist and distribution of forces exerted by supporting rollers 16 (or sliders) of the hoist on the guide 1.

The supporting surfaces 5 can be arranged at the angles α and β between the plane going through the given supporting surface 5 and the plane 8 going through the rise of the arch profile of the guide 1 construction in the range of 30°÷130°. The examples are given in FIG. 1, FIG. 2, FIG. 4, FIG. 6 when these angles are in the range of 30°÷90°. The example is given in FIG. 3 when the supporting surfaces 5 are arranged at the angles of α and β in the range of 90°÷130°. In FIG. 5 the example of arch profile of the guide is given when the external supporting surface 5 is arranged at the angle of α equal to 90°. The angles α and β can not be equal for supporting surfaces 5 arranged on different side elements 3 of the guide 1. The example is given in FIG. 6 where the guide 1 is not symmetrical, in this case in the figure the angles α₁, α₂ and β₁, β₂ on different side elements are equal, but the angles φ₁, φ₂ are not equal.

The supporting elements 4 can be fixed in the guide 1 profile, for example Π-shaped in cross-section (channel profile), as it is shown in figures, but can be fixed outside the profile as well, as it is shown in FIG. 6.

The attachment points 6 to the external support 7 of the guiding system are arranged closer to the edges of the side elements 3 and can be executed in the form of the holes, angles, posts or any other elements arranged along the length of the guide 1 and allowing to fix it to the wall of the well. The attachment points 6 play the role of supports for the guide 1 arch. The angle φ between the plane 17 going through the attachment points 6 along the length of the guide 1 and the plane 8 going through the rise of the arch profile of the guide 1 construction can differ from the angles α and β of supporting surfaces 5.

The guide can be executed in the form of rolled products that improves adaptability to manufacture of its execution.

When dimensions of the hoist are big, for example, of the car 19 (FIG. 7) of the cargo elevator it is possible to install additional guides 13 with additional supporting surfaces along which sliders 18 (or rollers) of the hoist slide.

The guiding system of the hoist operates in the following way.

The guide 1 is fixed by the attachment points 6 to the external support 7, for example, to the wall of the elevator well. The arch or triangular profile of the guide 1 creates stable construction possessing improved strength and rigidity. On the other hand the guide 1 of the arch profile on whose side elements 3 supporting surfaces 5 are executed assists precise alignment of the driving element 15 and the hoist drive itself relative to supporting elements 4.

The driving element 15 of the hoist moves along supporting elements 4 of the guiding system moving the hoist up or down. The hoist drive provides additional rigidity of the guide 1, because it completes the arch of the guide 1 and forms an original tie which moves along the guide 1 together with the hoist movement. Due to the mentioned properties the guiding system is rigid, distorting in a normalized way in operation.

The additional guides 13 when interacting of sliders 18 with supporting surfaces 14 suppress transverse vibrations of the hoist and thus contributes to location stability of the driving element 15 of the hoist drive relative to supporting elements 4.

### INDUSTRIAL APPLICABILITY

The hoist having the drive mechanism installed on the hoist with the proposed guide will have better operating characteristics. The hoist can possess greater load capacity and movement speed, less noisiness at the expense of greater rigidity of the guide construction and possibility of precise orientation of the driving element of the drive mated with supporting elements of the guide. The guide construction has not high specific consumption of materials, is adaptable to manufacture in execution.

What is claimed is:

1. A guiding system mountable on an external support for a hoist comprising a movable part and a hoist drive, the hoist drive comprising a driving element, the guiding system comprising
a guide comprising a central part and side elements, a cross-section of the guide being shaped as an arch or as a triangle,
supporting elements, the supporting elements being fixed in the central part of the guide along the length of the guide, the supporting elements supporting the driving element of the hoist drive,
supporting surfaces on each side element of the guide along its length, the supporting surfaces fixing the position of the driving element of the hoist drive and of the movable part of the hoist relative to the supporting elements, and
attachment units on each side element of the guide attaching the guide to the external support.

2. The guiding system of claim 1, wherein the support surfaces are symmetric relative to a plane going through the center of the arch cross-section of the guide or the vertex of the triangle cross-section of the guide.

3. The guiding system of claim 1, wherein the side elements comprise flanges and the supporting surfaces are on the flanges.

4. The guiding system of claim 3, wherein the flanges are on the side of the guide facing the driving element and on the side of the guide opposite to the driving element, the supporting surfaces being on the flanges.

5. The guiding system of claim 4, wherein the supporting surface on the flange on the side of the guide facing the driving element is at an angle α to a plane going through the center of the arch cross-section of the guide or the vertex of the triangle cross-section of the guide, the angle α being between 30° and 130°, and the supporting surface on the flange on the side of the guide opposite to the driving element is at an angle β to the plane going through the center of the arch cross-section of the guide or the vertex of the triangle cross-section of the guide, the angle β being between 30° and 130°.

6. The guiding system of claim 1, wherein the supporting elements are cogs of a spindle gear.

7. The guiding system of claim 1, wherein the supporting elements are rack teeth of a rack gear.

8. The guiding system of claim 1, wherein a cross-section of the central part of the guide is shaped as a Π.

9. The guiding system of claim 8, further comprising cogs of a spindle gear, the cogs being fixed in side flanges of the central part of the guide.

10. The guiding system of claim 1, wherein the guide is formed of rolled metal.

11. The guiding system of claim 1, further comprising additional guides attached to the external support on both sides of the guide, each of the additional guides comprising additional supporting surfaces.
